(19) United States
(12) Patent Application Publication
(10) Pub. No.: US 2013/0027799 A1
(43) Pub. Date: Jan. 31, 2013

(54) TOUCH PANEL AND DISPLAY DEVICE

(71) Applicants: YU-JU HSU, Tu-Cheng (TW); PO-SHENG SHIH, Tu-Cheng (TW)

(72) Inventors: YU-JU HSU, Tu-Cheng (TW); PO-SHENG SHIH, Tu-Cheng (TW)

(73) Assignee: SHIH HUA TECHNOLOGY LTD., Zhunan (TW)

(21) Appl. No.: 13/337,172

(22) Filed: Dec. 26, 2011

(30) Foreign Application Priority Data
Jul. 26, 2011 (TW) 100126264

(51) Int. Cl. G02B 5/22; B82Y 20/00

(52) U.S. Cl. 359/885; 977/742

(57) ABSTRACT

A touch panel including an optical element and a chromaticity improving layer is provided. A light transmittance of the optical element to the short wavelengths visible light is lower than a light transmittance to the long wavelengths visible light. A light transmittance of the chromaticity improving layer to the short wavelengths visible light is higher than a light transmittance to the long wavelengths visible light. A display device using the touch panel is also provided.

### CROSS-REFERENCE TO RELATED APPLICATIONS

This application claims all benefits accruing under 35 U.S.C. §119 from Taiwan Patent Application No. 100126264, filed on Jul. 26, 2011 in the Taiwan Intellectual Property Office, the disclosure of which is incorporated herein by reference. This application is related to an application entitled, “DISPLAY SCREEN AND DISPLAY DEVICE”, filed ______ (Atty. Docket No. US40577).

### BACKGROUND

1. Technical Field

The present disclosure relates to a touch panel and a display device.

2. Discussion of Related Art

There has been continuous growth in the number of electronic apparatuses equipped with optically transparent display touch panels. Users can operate the electronic apparatus by pressing or touching the touch panel with a finger, a pen, a stylus, or a tool while visually observing the display device through the touch panel. A demand exists for touch panels that are superior in visibility and reliable in operation.

Presently, different types of touch panels have been developed. Capacitance touch panels have several advantages, such as high accuracy and strong anti jamming ability, and thus have been widely used.

A conventional capacitance touch panel, includes a substrate, a transparent conductive layer formed thereon, four metal electrodes located at corners of the substrate to form an equipotential surface, and a hardening layer covering the transparent conductive layer. When a surface of the touch panel is touched by an object, a coupling capacitance is formed between the object and the transparent conductive layer. The current flows from the metal electrodes to the touch point. The position of the touch point can be determined by calculating the ratio and the intensity of the current through the electrodes.

However, due to different optical elements of the touch panel, such as the transparent conductive layer, have different light transmittance to different wavelengths of visible light. When a light irradiated from a display screen passes through the optical elements of the touch panel, a chromaticity will exist on the touch panel, and a color distortion will exist on the touch panel, because a light transmittance of the transparent carbon nanotube film to short wavelengths of visible light is lower than the light transmittance to long wavelengths of visible light, a chromaticity will exist on the touch panel. Therefore, a color distortion will exist on the touch panel to influence the visual effect.

What is needed, therefore, is to provide a touch panel and a display device having low chromaticity, which can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a top view of one embodiment of a touch panel.

FIG. 2 is a cross-sectional view of the touch panel shown in FIG. 1.

FIG. 3 shows one embodiment of a process of drawing a drawn carbon nanotube film from a carbon nanotube array.

FIG. 4 is a Scanning Electron Microscope (SEM) image of the drawn carbon nanotube film.

FIG. 5 is a cross-sectional view of another embodiment of a touch panel.

FIG. 6 is a cross-sectional view of one embodiment of a display device.

FIG. 7 is an isometric view of a liquid crystal display screen of FIG. 6.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

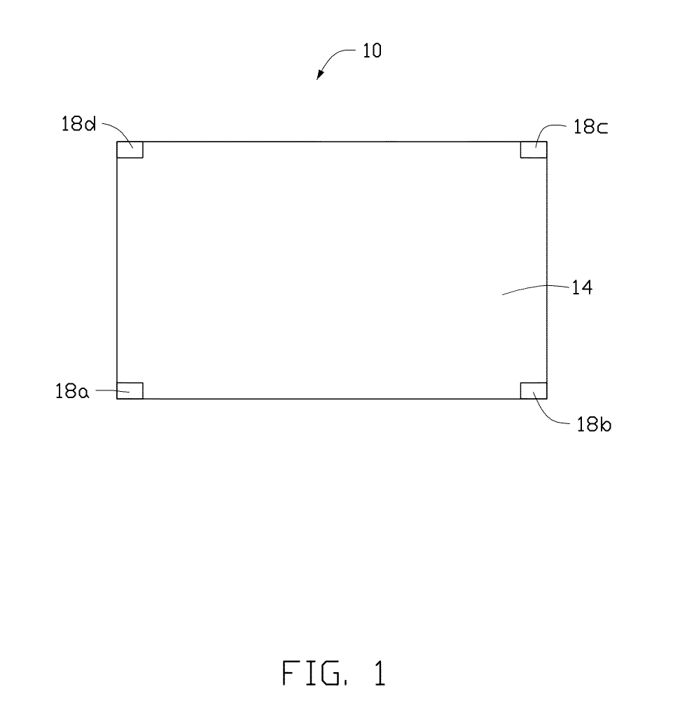

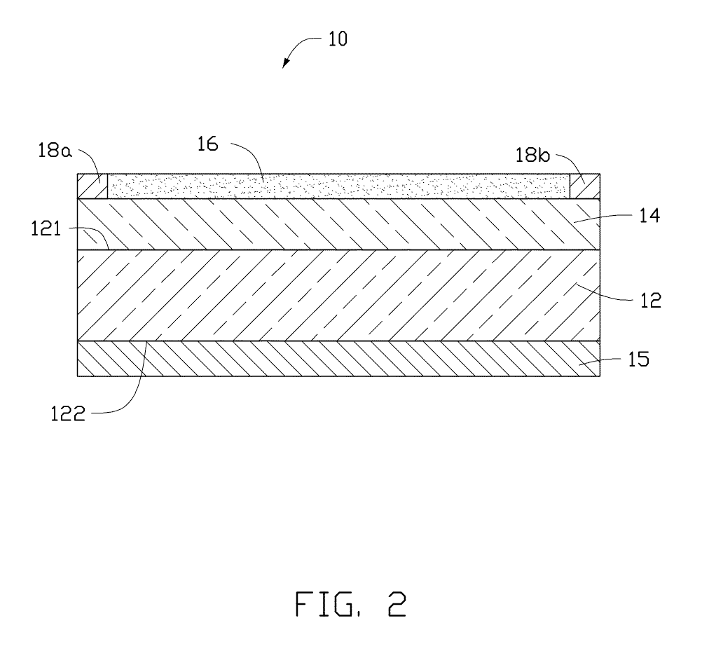

Referring to FIGS. 1 and 2, a touch panel 10 of one embodiment is provided. The touch panel 10 includes a substrate 12, a transparent conductive layer 14, a chromaticity improving layer 16, and four electrodes 18a, 18b, 18c, 18d.

The substrate 12 has a first surface 121 and a second surface 122 opposite to the first surface 121. The substrate 12 is transparent and insulative. The first surface 121 and the second surface 122 can be curved or planar. A material of the substrate 12 can be glass, quartz, diamond, or plastic. In one embodiment, the substrate 12 is a glass substrate.

The transparent conductive layer 14 is a transparent carbon nanotube layer located on the first surface 121. The transparent carbon nanotube layer can include at least one carbon nanotube film, and can be formed by a plurality of coplanar or stacked carbon nanotube films. A thickness of the transparent conductive layer 14 is not limited, as long as the transparent conductive layer 14 has a transmittance higher than 70%. Because the transparent carbon nanotube layer has different light transmittance to different wavelengths of visible light, when light passes through the transparent conductive layer 14, a chromaticity will exist on the touch panel 10. The chromaticity of the touch panel 10 is related to a thickness of the transparent conductive layer 14. The thickness of the transparent conductive layer 14 can be defined as A₁ micrometers.

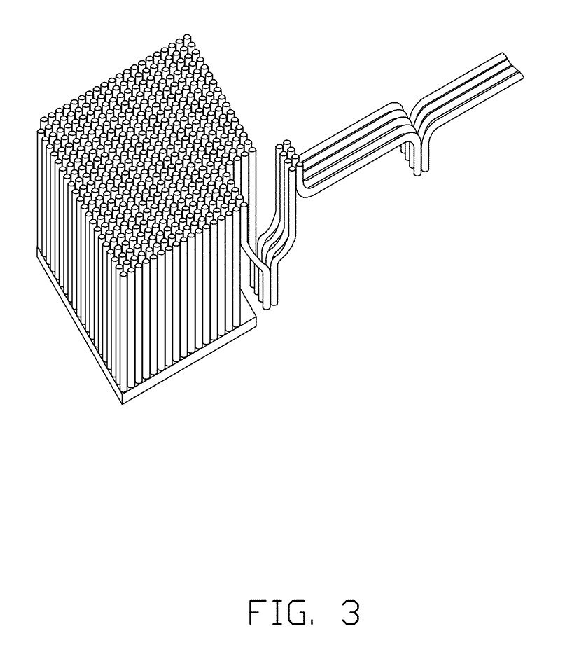

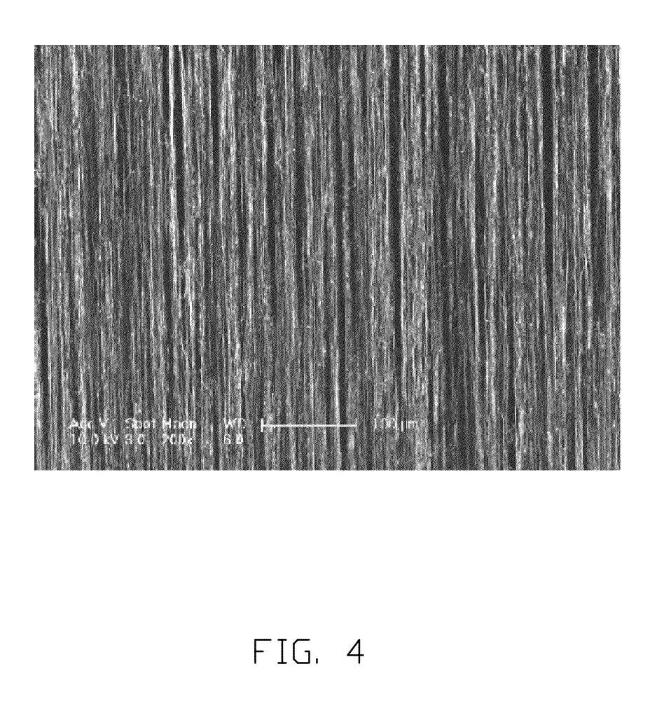

Referring to FIGS. 3 and 4, the carbon nanotube film can be a drawn carbon nanotube film formed by drawing from a carbon nanotube array. In one embodiment, the transparent conductive layer 14 is one drawn carbon nanotube film. The drawn carbon nanotube film can include a plurality of successive and oriented carbon nanotubes joined end to end by van der Waals attractive force. Each drawn carbon nanotube film can include a plurality of successively oriented carbon nanotube segments joined end-to-end by van der Waals attractive force therebetween. Each carbon nanotube segment includes a plurality of carbon nanotubes parallel to each other, and combined by van der Waals attractive force therebetween. A thickness of the drawn carbon nanotube film can be in a range from about 0.5 nanometers to about 100 micrometers. In one embodiment, the thickness of the drawn carbon nanotube film is about 0.3 micrometers. The plurality of carbon nanotubes can be single-wall carbon nanotube, double-wall carbon nanotube, and multi-wall carbon nanotube. A diameter of the single-wall carbon nanotube can be in a range from about 0.5 nanometers to about 50 nanometers. A diameter of the double-wall carbon nanotube can be in a range from about 1 nanometer to about 50 nanometers. A diameter of the multi-wall carbon nanotube can be in a range from about 1.5 nanometers to about 50 nanometers.

The drawn carbon nanotube film can be formed by the steps of: (a) providing an array of carbon nanotubes or a super-aligned array of carbon nanotubes; and (b) pulling out a carbon nanotube film from the array of carbon nanotubes, by using a tool (e.g., adhesive tape, pliers, tweezers, or another tool allowing multiple carbon nanotubes to be gripped and pulled simultaneously).

In step (a), a given super-aligned array of carbon nanotubes can be formed by the sub-steps of: (a1) providing a substantially flat and smooth substrate; (a2) forming a catalyst layer on the substrate; (a3) annealing the substrate with the catalyst layer in air at a temperature in a range from about 700° C. to about 900° C. for about 30 minutes to about 90 minutes; (a4) heating the substrate with the catalyst layer to a temperature in a range from about 500° C. to about 740° C. in a furnace with a protective gas therein; and (a5) supplying a carbon source gas to the furnace for about 5 minutes to about 30 minutes and growing the super-aligned array of carbon nanotubes on the substrate.

In step (a1), the substrate can be a P-type silicon wafer, an N-type silicon wafer, or a silicon wafer with a film of silicon dioxide thereon. A 4-inch P-type silicon wafer is used as the substrate in the present embodiment.

In step (a2), the catalyst can be made of iron (Fe), cobalt (Co), nickel (Ni), or any alloy thereof.

In step (a4), the protective gas can, beneficially, be made up of at least one of nitrogen (N₂), ammonia (NH₃), and a noble gas. In step (a5), the carbon source gas can be a hydrocarbon gas, such as ethylene (C₂H₄), methane (CH₄), acetylene (C₂H₂), ethane (C₂H₆), or any combination thereof.

The super-aligned array of carbon nanotubes can have a height of about 200 microns to about 400 microns and include a plurality of carbon nanotubes substantially parallel to each other and approximately perpendicular to the substrate.

In step (b), the drawn carbon nanotube film can be formed by the sub-steps of: (b1) selecting one or more carbon nanotubes having a predetermined width from the array of carbon nanotubes; and (b2) pulling the carbon nanotubes to form nanotube segments at an even/uniform speed to achieve a uniform drawn carbon nanotube film.

In step (b1), the carbon nanotube segment includes a plurality of carbon nanotubes substantially parallel to each other. The carbon nanotube segments can be selected using an adhesive tape as the tool to contact the super-aligned array of carbon nanotubes. In step (b2), the pulling direction is substantially perpendicular to the growing direction of the super-aligned array of carbon nanotubes.

During the pulling process, as the initial carbon nanotube segments are drawn out, other carbon nanotube segments are also drawn out end to end due to van der Waals attractive force between the ends of adjacent carbon nanotube segments. The drawing process ensures a substantially continuous and uniform drawn carbon nanotube film can be formed. The drawn carbon nanotube film formed by the pulling/drawing method has superior uniformity of thickness and conductivity over a disordered carbon nanotube film. Furthermore, the pulling/drawing method is simple, fast, and suitable for industrial applications.

The electrodes 18a, 18b, 18c, 18d are located, separately, on the corners of a surface of the transparent conductive layer 14. A material of the electrodes 18a, 18b, 18c, 18d can be metal. In one embodiment, the material of the electrodes 18a, 18b, 18c, 18d is silver. The electrodes 18a, 18b, 18c, 18d can be formed on the corners of the transparent conductive layer 14 by methods such as sputtering, electro-plating, or chemical plating. Alternatively, conductive adhesive, e.g., silver glue, can be used to adhere the electrodes 18a, 18b, 18c, 18d to the transparent conductive layer 14. The electrodes 18a, 18b, 18c, 18d can be electrically connected to the transparent conductive layer 14.

The chromaticity improving layer 16 can be located on the surface of the transparent conductive layer 14. A material of the chromaticity improving layer 16 can be TiO₂, ZrO₂, Nb₂O₅, Ta₂O₅, Al₂O₃, SiO₂, CeO₂, HfO₂, ZnS, MgF₂ or other dielectric material. The chromaticity improving layer 16 can be formed on the surface of the transparent conductive layer 14 by means of, vacuum evaporating, sputtering, slot coating, spin-coating, or dipping. The chromaticity improving layer 16 can be used to improve the chromaticity of the touch panel 10. In one embodiment, the chromaticity improving layer 16 is a two-layer SiO₂, formed by a dipping method.

Because a light transmittance of the transparent carbon nanotube film is lower to short wavelengths of visible light than a light transmittance to long wavelengths of visible light, a chromaticity will exist on the touch panel 10 if the chromaticity improving layer 16 is not used. The wavelengths of the short wavelength visible light is closer to the lower end of the visible spectrum and the wavelengths of the long wavelength visible light is closer to the higher end of the visible spectrum. The chromaticity of a touch panel can be represented by values of the lab color space of the International Commission on Illumination. Here, a* represents a green-red value of the touch panel, and b* represents a blue-yellow value of the touch panel. In the field of the display, the absolute values of a* and b* are expected to less than 2.0. More preferred, the absolute values of a* and b* are expected to be equal to about 0.

Referring to column 1 of Table 1, column 1 shows the values of the lab color space of five touch panels 10, No. 1 to No. 5, without the chromaticity improving layer 16. From column 1, the absolute values a* of the No. 1 to No. 5 touch panel 10 without the chromaticity improving layer 16 are less than 2.0. Therefore, there is no need to improve the a* of the No. 1 to No. 5 touch panel 10. However, the absolute values b* of the No. 1 to No. 5 touch panel 10 without the chromaticity improving layer 16 are greater than 2.0. Thus, b* of the No. 1 to No. 5 touch panel 10 without the chromaticity improving layer 16 need to be improved. The b* of the No. 1 to No. 5 touch panel 10 can be improved by the chromaticity improving layer 16. The b* of the No. 1 to No. 5 touch panel 10 without the chromaticity improving layer 16 is related to the thickness A₁ of the transparent conductive layer 14.

The chromaticity improving layer 16 can cause the touch panel 10 to have approximately the same light transmittance to different wavelengths of visible light. This is because a light transmittance of the chromaticity improving layer 16 to short wavelengths visible light can be higher than a light transmittance to long wavelengths visible light. In other words, the chromaticity improving layer 16 can have certain chromaticity itself.

The chromaticity of the chromaticity improving layer 16 can also be represented by the values of the lab color space of the International Commission on Illumination. In one embodiment, the b* of the chromaticity improving layer 16 is in a range from about −16.7×A₁ to about −1.67×A₁. In another embodiment, the b* of the chromaticity improving layer 16 is in a range from about −10.0×A₁ to about −1.67×A₁. In another embodiment, the thickness A₁ of the transparent conductive layer 14 is about 0.3 micrometers, and the b* of the chromaticity improving layer 16 is about −4.0×A₁. Thus, the b* of the chromaticity improving layer 16 is about −1.2.

TABLE 1

| | | |
|---|---|---|
| Column 1 | Column 2 | Column 3 |

| No. | a* | b* | a* | b* | Δa* | Δb* |
|---|---|---|---|---|---|---|
| 1 | 0.18 | 2.27 | −0.22 | 0.92 | −0.40 | −1.35 |
| 2 | −0.12 | 2.21 | −0.33 | 1.01 | −0.21 | −1.20 |
| 3 | −0.09 | 2.58 | −0.46 | 1.20 | −0.37 | −1.38 |
| 4 | 0.23 | 2.83 | −0.23 | 0.92 | −0.46 | −1.91 |
| 5 | 0.16 | 2.33 | −0.26 | 1.03 | −0.42 | −1.30 |
| Average | 0.07 | 2.44 | −0.30 | 1.01 | −0.37 | −1.43 |

Referring to Table 1, column 2 shows values of the lab color space of the No. 1 to No. 5 touch panel 10, and column 3 shows the variation of the lab color space between column 2 and column 1 From the column 2 and column 3, the absolute values of a* of the No. 1 to No. 5 touch panel 10 are less than 2.0. An average variation of a* between the No. 1 to No. 5 touch panel 10 and the No. 1 to No. 5 touch panel 10 without the chromaticity improving layer 16 is about −0.37. In other words, the a* of No. 1 to No. 5 touch panel 10 without the chromaticity improving layer 16 remains fundamentally unchanged. The absolute values of b* of the No. 1 to No. 5 touch panel 10 are less than 2.0. An average variation of b*between the No. 1 to No. 5 touch panel 10 and the No. 1 to No. 5 touch panel 10 without the chromaticity improving layer 16 is about −1.43. In other words, the b* of No. 1 to No. 5 touch panel 10 without the chromaticity improving layer 16 are significantly changed by the chromaticity improving layer 16. Therefore, the chromaticity of the touch panel is decreased by the chromaticity improving layer 16.

The chromaticity improving layer 16 can be located on a light path of the touch panel 10. Therefore, the touch panel 10 can have approximately the same light transmittance to different wavelengths of visible light.

The touch panel 10 can further include a shielding layer 15 located on the second surface 122 of the substrate 12. The shielding layer 15 is connected to the ground and plays a role of shielding electromagnetic interference, and thus enables the touch panel 10 to operate without interference. The shielding layer 15 can be a conductive polymer layer, an ITO layer, or a transparent carbon nanotube layer. In one embodiment, the shielding layer 15 is a transparent carbon nanotube layer. More specifically, the shielding layer 15 is one drawn carbon nanotube film. The thickness of the shielding layer 15 can be defined as A₂ micrometers.

If the touch panel 10 further includes a transparent carbon nanotube layer as a shielding layer 15, the b* of the chromaticity improving layer 16 is related to the thickness A₁ of the transparent carbon nanotube layer and the thickness A₂ of the shielding layer 15. In one embodiment, the b* of the chromaticity improving layer 16 is in a range from about −16.7×(A₁+A₂) to about −1.67×(A₁+A₂). In another embodiment, the b* of the chromaticity improving layer 16 is in a range from about −10.0×(A₁+A₂) to about −1.67×(A₁+A₂).

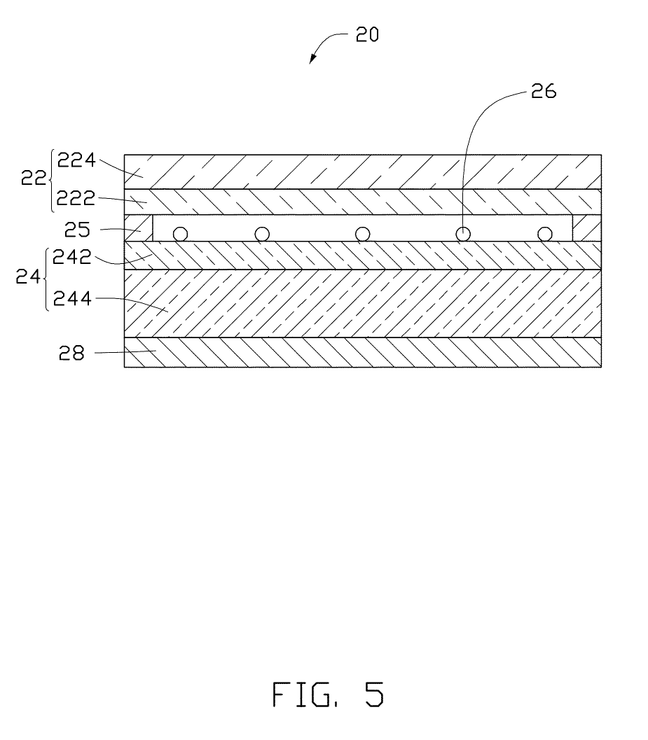

Referring to FIG. 5, a touch panel 20 of another embodiment is provided.

The touch panel 20 includes a first electrode plate 22, a second electrode plate 24, a plurality of dot spacers 26 located between the first electrode plate 22 and the second electrode plate 24, and a chromaticity improving layer 28.

The first electrode plate 22 includes a first substrate 224, a first transparent conductive layer 222, and a plurality of first electrodes (not shown). The first transparent conductive layer 222 is located on a surface of the first substrate 224 adjacent to the plurality of dot spacers 26. The plurality of first electrodes is located on a surface of the first transparent conductive layer 222 adjacent to the plurality of dot spacers 26, and electrically connected with the first transparent conductive layer 222.

The second electrode plate 24 includes a second substrate 244, a second transparent conductive layer 242, and a plurality of second electrodes (not shown). The second transparent conductive layer 242 is located on a surface of the second substrate 244 adjacent to the plurality of dot spacers 26. The plurality of second electrodes is located on a surface of the second transparent conductive layer 242 adjacent to the plurality of dot spacers 26, and electrically connected with the second transparent conductive layer 242.

The first substrate 224 and the second substrate 244 is transparent and insulative. A material of the first substrate 224 and the second substrate 244 can be glass, quartz, diamond, or plastic. In one embodiment, the first substrate 224 is a polyester substrate, the second substrate 244 is a glass substrate. The plurality of the first electrodes and second electrodes can be metal or any other suitable material. In one embodiment, each of the plurality of the first electrodes and second electrodes is a conductive silver paste.

An insulative layer 25 is located between the first and the second electrode plates 22 and 24. The insulative layer 25 is located around the second substrate 244. The first electrode plate 22 is located on the insulative layer 25. The first transparent conductive layer 222 is opposite to and spaced from the second transparent conductive layer 242. The plurality of dot spacers 26 is separately located on the second transparent conductive layer 242. A thickness of the insulative layer 25 is in a range from 2 microns to 20 microns. A material of the insulative layer 25 and the plurality of dot spacers 26 can be insulative resin or any other suitable insulative material. Insulation between the first electrode plate 22 and the second electrode plate 24 is provided by the insulative layer 25 and the plurality of dot spacers 26.

Both of the first transparent conductive layer 222 and the second transparent conductive layer 242 include a transparent carbon nanotube layer. The transparent carbon nanotube layer is basically the same as the transparent carbon nanotube layer of the transparent conductive layer 14. The thickness of the first transparent conductive layer 222 is defined as A₃ micrometers, and the thickness of the second transparent conductive layer 242 is defined as A₄ micrometers.

The chromaticity improving layer 28 is located on a surface of the second transparent conductive layer 242 far from the first transparent conductive layer 222. The chromaticity improving layer 28 is basically the same as the chromaticity improving layer 16.

Because both of the first transparent conductive layer 222 and the second transparent conductive layer 242 include a transparent carbon nanotube layer, when light passes through the first transparent conductive layer 222 and the second transparent conductive layer 242, a chromaticity will exist on the touch panel 20. Therefore, the chromaticity improving layer 28 can be used to improve the chromaticity of the touch panel 20. b* of the chromaticity improving layer 28 is related to the thickness A₃ of the first transparent conductive layer 222 and the thickness A₄ of the second transparent conductive layer 242. In one embodiment, the b* of the chromaticity improving layer 28 is in a range from about −16.7×(A₃+A₄) to about −1.67×(A₃+A₄). In another embodiment, the b* of the chromaticity improving layer 16 is in a range from about −10.0×(A₃+A₄) to about −1.67×(A₃+A₄).

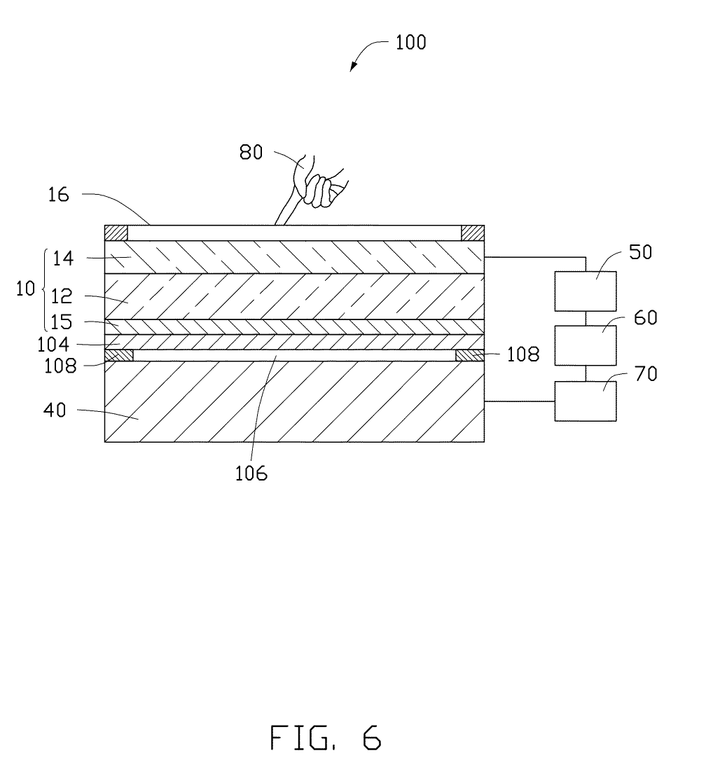

Referring to FIG. 6, a display device 100 of one embodiment is provided. The display device 100 includes a touch panel 10, a display element 40, a first controller 50, a central processing unit (CPU) 60, and a second controller 70.

The touch panel 10 is opposite and adjacent to the display element 40, and is connected to the first controller 50 by an external circuit. The touch panel 10 can be spaced from the display element 40 or directly installed on the display element 40. In one embodiment, the touch panel 10 is spaced from the display element 40, by a gap 106. The first controller 50, the CPU 60, and the second controller 70 are electrically connected. The CPU 60 is connected to the second controller 70 to control the display element 40.

The display element 40 can be, for example, a liquid crystal display, a field emission display, a plasma display, an electroluminescent display, a vacuum fluorescent display, a cathode ray tube, or another display device.

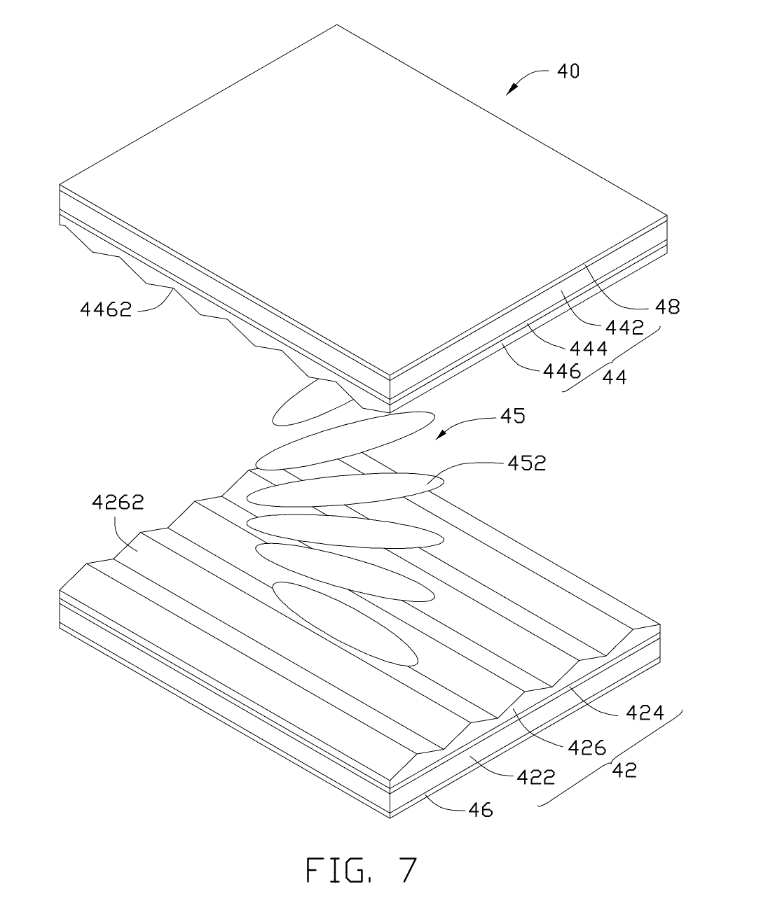

Referring to FIG. 7, according to one embodiment, the display element 40 is a liquid crystal display. The display element 40 includes a first substrate 42, a liquid crystal layer 45, and a second substrate 44.

The liquid crystal layer 45 including a plurality of liquid crystal molecules is sandwiched between the first substrate 42 and the second substrate 44. The first substrate 42 includes a first substrate plate 422, a first transparent electrode layer 424, and a first alignment layer 426. The first transparent electrode layer 424 is located on a surface of the first substrate plate 422 adjacent to the liquid crystal layer 45. The first alignment layer 426 is located on a surface of the first transparent electrode layer 424 adjacent to the liquid crystal layer 45. A first polarizer 46 can be formed on a surface of the first substrate plate 422 away from the liquid crystal layer. The second substrate 44 includes a second substrate plate 442, a second transparent electrode layer 444, and a second alignment layer 446. The second transparent electrode layer 444 is located on a surface of the second substrate plate 442 adjacent to the liquid crystal layer 45. The second alignment layer 446 is located on a surface of the second transparent electrode layer 444 adjacent to the liquid crystal layer 45. A second polarizer 48 can be located on a surface of the second substrate plate 442 away from the liquid crystal layer.

A plurality of substantially parallel first grooves 4262 is defined in a surface of the first alignment layer 426 facing the liquid crystal layer 35. A plurality of substantially parallel second grooves 4462 is defined in a surface of the second alignment layer 446 facing the liquid crystal layer 35. An alignment direction of the first grooves 4262 is substantially perpendicular to an alignment direction of the second grooves 4462.

The first substrate plate 422 and second substrate plate 442 are transparent and insulative. A material of the first substrate plate 422 and second substrate plate 442 can be glass, quartz, diamond, or plastic. In one embodiment, both the first substrate plate 422 and second substrate plate 442 are cellulose triacetate (CTA) substrates. The first transparent electrode layer 424 and second transparent electrode layer 444 can be conductive polymer layers, ITO layers, or transparent carbon nanotube layers. In one embodiment, the first transparent electrode layer 424 and second transparent electrode layer 444 are ITO layers. The first alignment layer 426 and second alignment layer 446 can be polymer layers or transparent carbon nanotube layers. In one embodiment, both of the first alignment layer 426 and second alignment layer 446 are polyimide layers. The first polarizer 46 and second polarizer 48 can be polymer layers or transparent carbon nanotube layers. In one embodiment, the first polarizer 46 and second polarizer 48 are polymer layers.

If both the touch panel 10 and the display element 40 include the at least one transparent carbon nanotube layer, only one chromaticity improving layer is needed to improve the chromaticity of the display device 100. The location of the chromaticity improving layer in the display device 100 is not limited, as long as the display device 100 has approximately the same light transmittance to different wavelengths of visible light.

A passivation layer 104 can be located on a surface of the shielding layer 15 away from the substrate 12. The material of the passivation layer 104 can be benzocyclobutene, polyester, acrylics, or other flexible materials. The passivation layer 104 can be spaced from the display element 40 a certain distance or installed on the display element 40. In one embodiment, two supportings 108 are located on a surface of the display element 40 adjacent to the passivation layer 104, to separate the touch panel 10 from the display element 40 by the gap 106. The passivation layer 104 can protect the display element 40 from mechanical damage.

The first controller 50, the CPU 60, and the second controller 70 are electrically connected. The first controller 50 is connected to the electrodes of the touch panel 10 to control the touch panel 10. The second controller 70 is connected to the display element 40 to control the display element 40.

In operation, when light emitting from the display element 40 passes through the transparent carbon nanotube layers of transparent conductive layer 14 and shielding layer 15, a chromaticity and a color distortion will exist. However, when the light further passes through the chromaticity improving layer 16, the chromaticity and the color distortion can be decreased by the chromaticity improving layer 16, to improve the visual effect of the display device 100.

In use of the display device 100, a voltage is applied to the transparent conductive layer 14 via electrodes 18a, 18b, 18c, 18d to form an equipotential surface. When a user operates the display device 100 by contacting the transparent conductive layer 14 of the touch panel 10 with a touching object, such as a finger, a pen/stylus 80, or the like, a coupling capacitance is formed between the touching object and the transparent conductive layer 14. Currents then flow from the electrodes 18a, 18b, 18c, 18d to the touching point. The position of the touching point is confirmed via calculating the ratio and the intensity of the current through the four electrodes 18a, 18b, 18c, 18d. The first controller 50 then transforms the changes in currents into coordinates of the pressing point, and sends the coordinates of the pressing point to the CPU 60. The CPU 60 then sends out commands according to the coordinates of the pressing point and further controls a display of the display element 40.

Because the light transmittance of the transparent carbon nanotube layer to short wavelengths of visible light is lower than the light transmittance to long wavelengths of visible light, the transparent carbon nanotube layer itself can be used as a chromaticity improving layer. For example, when one of the optical elements in the touch panel or display element, such as the transparent conductive layer, shielding layer, transparent electrode layer, alignment layer, or polarizer, has a higher light transmittance to short wavelengths of visible light than to long wavelengths of visible light, a transparent carbon nanotube layer can be used so that the touch panel or display element can have approximately the same light transmittance to different wavelengths of visible light. Thus, the visual effect of the touch panel or display element can be improved.

It is to be understood the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

What is claimed is:

1. A touch panel comprising:
an optical element having a lower light transmittance to short wavelength visible light than to long wavelength visible light; and
a chromaticity improving layer having a higher light transmittance to short wavelength visible light than to long wavelength visible light, wherein wavelengths of the short wavelength visible light is closer to the lower end of the visible spectrum and wavelengths of the long wavelength visible light is closer to the higher end of the visible spectrum.

2. The touch panel as claimed in claim 1, wherein a material of the chromaticity improving layer is selected from the group consisting of TiO₂, ZrO₂, Nb₂O₅, Ta₂O₅, Al₂O₃, SiO₂, CeO₂, HfO₂, ZnS, and MgF₂.

3. The touch panel as claimed in claim 1, wherein the chromaticity improving layer is formed by means of vacuum evaporating, sputtering, slot coating, spin-coating, or, dipping.

4. The touch panel as claimed in claim 1, wherein the optical element comprises a first transparent carbon nanotube layer.

5. The touch panel as claimed in claim 4, wherein a thickness of the first transparent carbon nanotube layer is defined as A in micrometers, and a blue-yellow value of the chromaticity improving layer is in a range from about −16.7×A to about −1.67×A.

6. The touch panel as claimed in claim 5, wherein the blue-yellow value of the chromaticity improving layer is in a range from about −10.0×A to about −1.67×A.

7. The touch panel as claimed in claim 4, wherein a thickness of the first transparent carbon nanotube layer is about 0.3 micrometers, and a blue-yellow value of the chromaticity improving layer is about −1.2.

8. The touch panel as claimed in claim 5, further comprising a second optical element, the second optical element comprising a second transparent carbon nanotube layer.

9. The touch panel as claimed in claim 8, wherein a thickness of the second transparent carbon nanotube layer is defined as B in micrometers, the blue-yellow value of the chromaticity improving layer is in a range from about −16.7×(A+B) to about −1.67×(A+B).

10. A display device comprising:
a touch panel comprising:
at least one optical element having a lower light transmittance to short wavelength visible light than to long wavelength visible light; and
a chromaticity improving layer having a higher light transmittance to short wavelength visible light than to long wavelength visible light, wherein wavelengths of the short wavelength visible light is closer to the lower end of the visible spectrum and wavelengths of the long wavelength visible light is closer to the higher end of the visible spectrum.

11. The display device as claimed in claim 10, wherein a thickness of the at least one optical element is defined as A in micrometers, and a blue-yellow value of the chromaticity improving layer is in a range from about −16.7×A to about −1.67×A.

12. The display device as claimed in claim 10, further comprising a display element located opposite and adjacent to the touch panel.

13. The display device as claimed in claim 12, wherein the chromaticity improving layer is located in the display element or the touch panel.

14. The display device as claimed in claim 12, further comprising a second optical element having a lower light transmittance to short wavelength visible light than to long wavelength visible light.

15. The display device as claimed in claim 14, wherein the second optical element is located in the display element or the touch panel.

16. The display device as claimed in claim 10, wherein the at least one optical element comprises a first transparent carbon nanotube layer.

17. The display device as claimed in claim 16, wherein the first transparent carbon nanotube layer comprises a plurality of carbon nanotubes combined end to end by van der Waals attractive force and arranged approximately along a same direction.

18. A touch panel comprising:
at least one optical element having a higher light transmittance to short wavelength visible light than to long wavelength visible light; and
a chromaticity improving layer having a lower light transmittance to short wavelength visible light than to long wavelength visible light, wherein wavelengths of the short wavelength visible light is closer to the lower end of the visible spectrum and wavelengths of the long wavelength visible light is closer to the higher end of the visible spectrum.

19. The touch panel as claimed in claim 18, wherein the chromaticity improving layer comprises a first transparent carbon nanotube layer.

20. The touch panel as claimed in claim 19, wherein the first transparent carbon nanotube layer comprises a plurality of carbon nanotubes combined end to end by van der Waals attractive force and arranged approximately along a same direction.
